(19) United States
(12) Patent Application Publication
(10) Pub. No.: US 2021/0284845 A1
(43) Pub. Date: Sep. 16, 2021

(54) TREATED POROUS MATERIAL

(71) Applicants: Xue Chen, Manvel, TX (US); Stephen King, League City, TX (US)

(72) Inventors: Xue Chen, Manvel, TX (US); Stephen King, League City, TX (US)

(21) Appl. No.: 16/334,606

(22) PCT Filed: Sep. 28, 2017
(86) PCT No.: PCT/US2017/053996

§ 371 Date: Mar. 19, 2019

Related U.S. Application Data
(60) Provisional application No. 62/401,973, filed on Sep. 30, 2016.

(51) Int. Cl. C08L 97/02; C08L 63/00; B27K 3/15; B27K 3/34

(52) U.S. Cl. CPC C08L 97/02; C08L 63/00; C08L 2201/52; B27K 3/34; C08L 2205/03; B27K 3/15

(57) ABSTRACT

A treated cellulosic material comprising a cellulosic material having a porous structure defining a plurality of pores, the cellulosic material comprising wood including wood or wood composite materials, at least a portion of the pores containing the reaction product of one or more of the following: a water soluble polyol, an epoxy-containing resin, a catalyst or curing agent, and the cellulosic material. A method for preparing a treated cellulosic material comprising providing a cellulosic material; a first treatment protocol comprising impregnating the cellulosic material with a water-soluble polyol; and a second treatment protocol comprising impregnating the cellulosic material with an epoxy-containing resin.

### BACKGROUND

Porous materials, such as cellulosic materials, need to be protected from, insect attack, rot and water impregnation to help preserve the physical properties of the cellulosic material. One example of such a cellulosic material is wood. A variety of treating agents and preservation methods are known to preserve cellulosic materials.

Modern preservation methods typically involve pressure treating the cellulosic material with a treating agent. Pressure treatment typically allows the treating agent to penetrate throughout the porous structure of the cellulosic material. The treating agent is typically a chemical compound selected to impart the desired physical properties to the cellulosic material. For example, treating agents that increase hardness, add water resistance and improve the dimensional stability of the cellulosic material are of interest. Wood is capable of absorbing as much as 100% of its weight in water which causes the wood to swell, which after loss of water through evaporation causes the wood to shrink. This process of water absorption/evaporation is non-uniform and creates internal stresses in the wood leading to splitting, warping, bowing, crooking, twisting, cupping, etc. Also, water can serve as a pathway for organisms that degrade the cellulosic material, such as insects or fungus. Treating agents that repel insects, or minimize the formation of fungi, or improve the overall durability of the cellulosic material are of interest. Further, treating agents can improve wind resistance, ultraviolet radiation resistance, stability at high and low temperatures, pest resistance, fire resistance and other issues which might affect the physical properties of the cellulosic material.

An improved treating agent for cellulosic materials is desired.

### SUMMARY

A treated cellulosic material comprising a cellulosic material having a porous structure defining a plurality of pores, the cellulosic material comprising wood including wood or wood composite materials, at least a portion of the pores containing the reaction product of one or more of the following: a water soluble polyol, an epoxy-containing resin, a catalyst or curing agent, and the cellulosic material.

A method for preparing a treated cellulosic material comprising providing a cellulosic material; a first treatment protocol comprising impregnating the cellulosic material with a water-soluble polyol; and a second treatment protocol comprising impregnating the cellulosic material with an epoxy-containing resin.

### DETAILED DESCRIPTION

As used herein, the term “porous material” refers to a material which is permeable such that fluids are movable therethrough by way of pores or other passages. An example of a porous material is a cellulosic material. Other examples of porous materials include stone, concrete, ceramics, and derivatives thereof. As used herein, the term “cellulosic material” refers to a material that includes cellulose as a structural component. Examples of cellulosic materials include wood, paper, textiles, rope, particleboard and other biologic and synthetic materials. As used herein, wood includes solid wood and all wood composite materials (e.g., chipboard, engineered wood products, etc.). Cellulosic materials generally have a porous structure that defines a plurality of pores.

As used herein, unless otherwise indicated, the phrase “molecular weight” refers to the weight average molecular weight.

A “treated cellulosic material” is a cellulosic material that has been treated with a treating agent to modify the properties of the cellulosic material. The properties modified by the treating agent include, but are not limited to, increased hydrophobicity, dimensional stability, fungi resistance, insect resistance, hardness, surface appearance, UV stability, fire resistance, and coatability. Increasing the hydrophobicity of a cellulosic material can provide other ancillary benefits, such as dimensional stability, by reducing the rate of water adsorption and evaporation, thus reducing the internal stresses of expanding and contracting.

A “treating agent” is a substance that, when combined with the cellulosic material, modifies the properties of the cellulosic material. In one instance, the treating agent comprises both a water-soluble polyol and an epoxy-containing resin. The treating agent is applied to the cellulosic material. The preferred method of applying the treating agent to the cellulosic material is through impregnation using pressure treatment. In one instance, the water-soluble polyol is applied to the cellulosic material as part of a solution. Other methods of applying the treating agent are known, such as brushing, spraying, dipping, soaking and extrusion. Once applied, the treating agent will permeate the surface of the cellulosic material. As described herein, the water-soluble polyol and the epoxy-containing resin may be applied to the cellulosic material in separate processing steps.

As used herein, the use of the term “(meth)” followed by another term such as acrylate refers to both acrylates and methacrylates. For example, the term “(meth)acrylate” refers to either acrylate or methacrylate; the term “(meth)acrylic” refers to either acrylic or methacrylic; and the term “(meth)acrylic acid” refers to either acrylic acid or methacrylic acid.

As used herein, “water-soluble” means that the solution has at least 10 wt % of polyol in water without phase separation, precipitation, or solid residue. In one instance, the water-soluble polyol is a polymer having 2 or more hydroxyl groups. Examples of water-soluble polyols include, polyethylene glycol, polyvinyl alcohol, ethylene oxide/propylene oxide copolymer, ethoxylated glycerin, ethoxylated trimethylolpropane or ethoxylated sugars. In one instance, the water-soluble polyol is selected having a molecular weight of less than 10000. In one instance, the water-soluble polyol is selected having a molecular weight of less than 2000. In one instance, the water-soluble polyol is selected having a molecular weight of less than 1500. In one instance, the water-soluble polyol is selected having a molecular weight of at least 300. In one instance, the water-soluble polyol is a polyethylene glycol having a molecular weight of less than 1000. CARBOWAX™ Polyethylene Glycol 1000 (The Dow Chemical Company) is an example of a commercially available polyethylene glycol. In the case of copolymers, it can be random, block, or a graft copolymer. As used herein, copolymer refers to a polymer formed by uniting two or more monomers. Examples of copolymers include bipolymers, terpolymers, tetrapolymers, and other higher-ordered copolymers.

In one instance, the water-soluble polyol is a constituent part of an aqueous solution. In one instance, the solution is a medium that comprises the water-soluble polyol, water, and optionally an organic solvent. The solution is prepared such that the viscosity of the solution is suitable for penetrating the pores of the cellulosic material for distribution through the cellulosic material. In one instance, the viscosity of the solution is from 10 cP to 5000 cP at ambient temperature. In one instance, the viscosity of the solution is less than 500 cP at ambient temperature. In one instance, the solution also comprises one or more additives. In one instance, the polymer content of the solution is 1 to 75 weight percent. In one instance, the polymer content of the solution is 5 to 60 weight percent. In one instance, the polymer content of the solution is 10 to 55 weight percent. In one instance, the polymer content of the solution is 15 to 50 weight percent. In one instance, the polymer content of the solution is 25 to 45 weight percent. Preferably, the polymer content of the solution is 30 to 40 weight percent. In one instance the solution includes a solvent, for example, an organic solvent such as an oxygenated solvent, a hydrocarbon solvent, a halogenated solvent, or a combination thereof.

In one instance, the epoxy-containing resin is an epoxy. In one instance the epoxy-containing resin is an epoxy imbibed thermoplastic polymer. An example of a commercially available epoxy imbibed thermoplastic polymer is Maincote™ AEH-10 (available from The Dow Chemical Company). In one instance, the epoxy portion of the epoxy-containing resin comprises a single epoxy. In one instance, the epoxy portion of the epoxy-containing resin comprises a mixture of epoxies. In one instance, the epoxy portion of the epoxy-containing resin is a diglycidyl ether of bisphenol A, the diglycidyl ether of bisphenol F, 1,4-butanediol diglycidyl ether, 1,6-hexanediol diglycidyl ether, the diglycidyl ester of phthalic acid, 1,4-cyclohexanedimethanol diglycidyl ether, 1,3-cyclohexanedimethanol diglycidyl ether, the diglycidyl ester of hexahydrophthalic acid, or a novolac resin, or a combination thereof. In one instance, the thermoplastic portion of the epoxy-containing resin comprises a (meth)acrylic latex. Monomers suitable for the preparation of acrylic latexes include acrylates and methacrylates such as methyl acrylate, ethyl acrylate, butyl acrylate, 2-ethylhexyl acrylate, methyl methacrylate, ethyl methacrylate, butyl methacrylate, and 2-ethylhexyl methacrylate, and combinations thereof.

In one instance, the epoxy-containing resin is prepared as an epoxy dispersion stabilized by an emulsifying agent. The dispersion is preferably an aqueous dispersion. The epoxy resin may be a solid epoxy resin or a liquid epoxy resin. Where a liquid epoxy resin is selected, an aqueous solution is formed. In one instance the dispersion includes water, a solid epoxy resin, and one or more emulsifying agents. The aqueous dispersion is preferably a stable dispersion. A stable dispersion is a dispersion that, once formed, resists change in its properties over time and is therefore suitable for penetrating the pores of the cellulosic material. In one instance, the dispersion is substantially solvent-free, for example, having less than 1% by volume solvent. In one instance the aqueous dispersion has less than 0.1% by volume solvent. In one instance, the dispersion is solvent-free. Examples of the dispersion which are available commercially include OUDRASperse™, available from The Dow Chemical Company, e.g., OUDRASperse™ WB 3001, OUDRASperse™ WB 4001, and OUDRASperse™ WB 6001. In one instance, the emulsifying agent is a surfactant. In one instance the surfactant is nonionic, or anionic. In one instance the surfactant is an epoxy functional surfactant. An epoxy functional surfactant is a surfactant that contains a functionality that reacts with an epoxy containing material to become an integral part of the cured matrix. In one embodiment the surfactant is treated with an epihalohydrin or a multifunctional (di or higher) epoxide to give the epoxy functional surfactant. In one preferred embodiment the surfactant treated with an epihalohydrin or a multifunctional (di or higher) epoxide is nonionic. Examples of nonionic surfactants include alkoxylated alcohols alkoxylated alkyl phenols, alkoxylated esters, alkoxylated acid esters, ethylene oxide/propylene oxide copolymers (block and random), amine alkoxylates, alkoxylated polyols, and thiols. In one instance the dispersion includes a combination of epoxy functional surfactants. In another instance the dispersion includes a combination of an epoxy functional surfactant and another surfactant.

The aqueous dispersion containing the epoxy-containing resin is prepared such that the suspended particle size in the dispersion is suitable for penetrating the pores of the cellulosic material for distribution through the cellulosic material. In one instance, the solids of the aqueous dispersion have an average particle size less than 50 micrometers. In one instance, the solids of the aqueous dispersion have an average particle size less than 500 nm. In one instance, the solids of the aqueous dispersion have an average particle size less than 350 nm. In one instance, the solids of the aqueous dispersion have an average particle size less than 250 nm. In one instance, the solids of the aqueous dispersion have an average particle size from 100 to 250 nm. In one instance, the dispersion or solution also comprises one or more additives. In one instance, any solids present in the aqueous dispersion are held in a stable suspension and are transportable by the dispersion into the pores of the cellulosic material. In one instance, the solid content of the dispersion is 0.1 to 90 weight percent. In one instance, the solid content of the dispersion is 1 to 80 weight percent. In one instance, the solid content of the dispersion is 5 to 70 weight percent. In one instance, the solid content of the dispersion is 10 to 60 weight percent. In one instance, the solid content of the dispersion is 12 to 50 weight percent. In one instance, the solid content of the dispersion is 15 to 40 weight percent. The aqueous dispersion is prepared such that the viscosity of the epoxy-containing dispersion is suitable for penetrating the pores of the cellulosic material for distribution through the cellulosic material. In one instance, the viscosity of the solution or dispersion is from 1 cP to 5000 cP at ambient temperature. In one instance, the viscosity of the solution or dispersion is less than 1000 cP at ambient temperature.

In one instance, the solution containing the water-soluble polyol is combined with the solution or dispersion containing the epoxy-containing resin to allow treatment of the porous material in a single step.

In one instance, a catalyst or curing agent is introduced to the cellulosic material. In one instance, a catalyst or a curing agent is combined with the dispersion or solution containing the epoxy-containing resin just prior to treatment of the porous material. In one instance, the catalyst or curing agent is added in a distinct treatment step from the epoxy-containing resin. The catalyst or curing agent is selected, such that when combined with the epoxy-containing resin, it polymerizes, crosslinks, or cures at least a portion of the epoxy-containing resin. Examples of suitable catalysts include amines, phosphines, ammonium, phosphonium, arsonium, sulfonium moieties, and any combination thereof. Examples of curing agents include any of the co-reactive or catalytic curing materials known to be useful for curing epoxy resin based compositions. Such co-reactive curing agents include, for example, imidazole, polyamine, polyamide, polyaminoamide, dicyandiamide, polyphenol, polymeric thiol, polycarboxylic acid and anhydride, and any combination thereof or the like. Other specific examples of co-reactive curing agent include phenol novolacs, bisphenol-A novolacs, phenol novolac of dicyclopentadiene, cresol novolac, diaminodiphenylsulfone, styrene-maleic acid anhydride (SMA) copolymers; and any combination thereof. Among the conventional co-reactive epoxy curing agents, amines and amino or amido containing resins and phenolics are preferred. Suitable catalytic curing agents include tertiary amine, quaternary ammonium halide, Lewis acids such as boron trifluoride, Bronsted acids such as sulfuric acid and organosulfonic acids, and any combination. In one instance the catalyst or curing agent is formulated as part of a liquid solution suitable for treating the porous material. As is known in the art, some catalysts or curing agents are co-reactive with the epoxy-containing resin, meaning that, the catalyst or curing agent will react with the epoxy-containing resin to form a portion of the reaction product. In one instance, the cellulosic material serves to catalyze the reaction of the epoxy-containing resin and a separate catalyst or curing agent are unnecessary. Preferably, a catalyst or curing agent are introduced to the cellulosic material.

The treating agent is combined with the cellulosic material. Preferably, the treating agent is introduced to the cellulosic material by pressure treatment, as described herein. In another instance, the treating agent is introduced to the cellulosic material by other techniques known in the art, for example, brushing, dipping, soaking, spraying, and extrusion. The treating agent becomes impregnated in at least a portion of the pores of the cellulosic material, and thereby increases the weight of the cellulosic material. In one instance, the treating agent increases the weight of the cellulosic material by 1 to 80 percent (as calculated after drying the cellulosic material). In one instance, the treating agent increases the weight of the cellulosic material by 5 to greater than 100 percent (as calculated after drying the cellulosic material). In one instance, the catalyst or curing agent is introduced to the cellulosic material in a separate processing step from the introduction of the treating agent. In one instance, the catalyst or curing agent are introduced to the cellulosic material as part of, or concurrently with, the treating agent.

In one instance, the treating agent comprises one or more additives. The additive may be included as part of the solution containing the water-soluble polyol, as part of the solution or dispersion containing the epoxy-containing resin, as part of the solution containing the catalyst or curing agent, or may be included separately therefrom. Additives which are known to add properties to treated cellulosic materials are suitable, such as, flame retardants, dispersants and/or dyes. For example, the additives may be organic compounds, metallic compounds, or organometallic compounds. In one instance, the additive is a material which improves the wetting or penetration of the treating agent into the wood, for example, solvents or surfactants (anionic, cationic or nonionic) that are stable in the solution. Examples of additives include, solvents, fillers, thickeners, emulsifiers, dispersing agents, buffers, pigments, penetrants, antistatic agents, odor substances, corrosion inhibitors, preservatives, siliconizing agents, rheology modifiers, anti-settling agents, anti-oxidants, other crosslinkers (e.g. diols and polyols), optical brighteners, waxes, coalescence agents, biocides and anti-foaming agents. Such fillers may include silica, Ca(OH)₂ or CaCO₃. In addition, the treating agent may be used in conjunction with wood preservatives containing, for example, cupric-ammonia, cupric-amine, cupric-ammonia-amine complexes, quaternary ammonium compounds, or other systems. For example, the treating agent may be used with Alkaline Copper-Quaternary ammonium (ACQ) preservative systems. The treating agent may also be used with wood preservative technologies which use zinc salts or boron containing compounds. Optionally, other additives such as insecticides, termiticides, and fungicides s may be added to the treating agent. In one instance, the additive is included as part of the dispersion or the solution. In one instance, one or more surfactant is added to the dispersion or the solution. In one instance, a surfactant is selected which reduces gelling of the polymer at the surface of the cellulosic material. In one instance, a surfactant is selected which increases the amount of treating agent impregnated in the cellulosic material. For example, suitable surfactants may be nonionic, anionic, or cationic. Examples of nonionic surfactants include: alkoxylated alcohols, alkoxylated alkyl phenols, fatty acid esters, amine and amide derivatives, alkylpolyglucosides, ethylene oxide/propylene oxide copolymers, polyols and alkoxylated polyols. For example, a nonionic surfactant is TERGITOL™ L-62, commercially available from The Dow Chemical Company. Examples of anionic surfactants include: alkyl sulfates, alkyether sulfates, sulfated alkanolamides, alpha olefin sulfonates, lignosulfonates, sulfosuccinates, fatty acid salts, and phosphate esters. For example, an anionic surfactant is DOWFAX™ C10L, commercially available from the Dow Chemical Company. Examples of cationic surfactants include alkyltrimethylammonium salts.

Preferably, the cellulosic material is prepared as a treated cellulosic material by pressure treatment. The pressure used to pressure treat the cellulosic material may be either higher or lower than atmospheric pressure. In one instance, the pressure is lower than ambient pressure, for example, 0.0001 to 0.09 MPa (0.75 to 675 mmHg). In another instance, the pressure is greater than ambient pressure, for example, 0.1 to 1.7 MPa (750 to 12750 mmHg). It is envisioned that pressure treatment processes known in the art are suitable for impregnating the cellulosic material with the treating agent. The temperature for the pressure treatment may be performed at a range of temperatures, for example, from ambient to 150° C.

In one instance, the treated cellulosic material is prepared according to at least a first treatment protocol and a second treatment protocol. In one instance, the first treatment protocol comprises impregnating the cellulosic material with the water-soluble polyol. The first treatment protocol comprises one or more of the following steps: (a) depositing the cellulosic material in a vessel; (b) holding the vessel at vacuum for 5 to 60 minutes; (c) introducing the water-soluble polyol to the vessel; (d) pressurizing the vessel to 1.03 MPa for 5 to 60 minutes; (e) draining the excess water-soluble polyol; (f) optionally removing excess water-soluble polyol by vacuum and (g) air drying the cellulosic material at 20 to 60° C. for 24 to 48 hours. In one instance, the water-soluble polyol is part of the solution. In one instance, step (d) is performed at ambient pressure.

In one instance, the product of the first treatment protocol is subsequently prepared according to a second treatment protocol that impregnates the cellulosic material with the epoxy-containing resin. The second treatment protocol comprises one or more of the following steps: (a) depositing the cellulosic material prepared according to the first treatment protocol in a vessel; (b) introducing the epoxy-containing resin to the vessel; (c) holding the vessel at either vacuum or increased pressure for 5 to 60 minutes; (d) optionally removing excess epoxy-containing resin by vacuum; and (e) air drying the cellulosic material at 60° C. for 24 to 48 hours. In one instance, the first treatment protocol and the second treatment protocol are combined whereby step (c) of the first treatment protocol is modified to also include the epoxy-containing resin. In one instance, the second treatment protocol is performed prior to the first treatment protocol.

In one instance, the treated cellulosic material undergoes an optional curing protocol. The curing protocol comprises one or more of the following steps: (a) depositing the cellulosic material in a vessel; (b) introducing the catalyst or the curing agent to the vessel; (c) holding the vessel at either vacuum or increased pressure for 5 to 60 minutes; (d) optionally removing excess catalyst or curing agent by vacuum; and (e) air drying the cellulosic material at 60° C. for 24 to 48 hours. In one instance, the curing protocol is performed after the first treatment protocol. In one instance, the curing protocol is performed after the second treatment protocol. In one instance, the curing protocol is concurrent with the first treatment protocol. In one instance, the curing protocol is performed concurrent with the second treatment protocol.

The several drying steps may be performed at a range of temperatures, whereby the duration of the air drying step is proportional to the temperature. Suitable air-drying temperatures are between room temperature (roughly 20° C.) and 180° C. The drying may be performed in air, in nitrogen, or other suitable atmosphere.

The result of the first treatment protocol and the second treatment protocol is a cellulosic material having pores, wherein at least a portion of the pores contain the reaction product comprising one or more of the following: a water-soluble polyol, an epoxy-containing resin and a catalyst or curing agent. The reaction product may include one or more of the following: (1) the reaction product of an epoxy-containing resin with an epoxy-containing resin, (2) the reaction product of an epoxy-containing resin with a catalyst or curing agent, (3) the reaction product of an epoxy-containing resin with the water-soluble polyol, (4) the reaction product of an epoxy-containing resin with the cellulosic material, (5) the reaction product of an epoxy-containing resin, a water-soluble polyol, and the cellulosic material, (6) the reaction product of an epoxy-containing resin, the catalyst or curing agent, and a water-soluble polyol, (7) the reaction product of an epoxy-containing resin, the catalyst or curing agent, the water-soluble polyol, and the cellulosic material. As is illustrated by this non-exclusive list, it is anticipated that the impregnation process described herein will result in a variety of reactions that will combine the water-soluble polyol, the epoxy-containing resin, the catalyst or curing agent, and the cellulosic material into a variety of reaction products, the combination of which, provide the improved characteristics to the cellulosic material.

### Examples

A water immersion test is used to determine the water repellency of the treated cellulosic material according to the American Wood Protection Association Standard E4-11 procedure (Standard Method of Testing Water Repellency of Pressure Treated Wood). The water immersion test involves first, providing both a treated wafer, comprising a treated cellulosic material prepared as described herein, and a control wafer, comprising a cellulosic material treated according to the first treatment protocol described herein except that the solution is replaced by distilled water; second, measuring the tangential dimension of both the treated wafer and the control wafer to provide an initial tangential dimension (T₁) (where the tangential dimension is perpendicular to the direction of the grain of the cellulosic material); third, placing both the treated wafer and the control wafer in a conditioning chamber maintained at 65±3% relative humidity and 21±3° C. until a constant weight is achieved; fourth, immersing both the treated wafer and the control wafer in distilled water at 24±3° C. for 30 minutes; and fourth, measuring the tangential dimension of both the treated wafer and the control wafer following removal from the water to provide a post tangential dimension (T₂).

DoN refers to the degree of neutralization of the carboxylic acid functionality in the polymer.

The percent swelling (S) for each individual wafer (both the treated wafer and the control wafer) is calculated as:

$$S ( \% ) = \frac{{T}_{2} - {T}_{1}}{{T}_{1}} \times 100$$

In each of the Examples herein, the percent swelling of the control wafer is 3.0%.

Water-repellency efficiency (WRE) is used to determine the effectiveness of the treating agent in adding water repellant properties to the treated cellulosic material. WRE is calculated as:

$$W R E ( \% ) = \frac{{S}_{1} - {S}_{2}}{{S}_{1}} \times 100$$

S₁ refers to the percent swelling of the untreated wafer; S₂ refers to the percent swelling of the treated wafer. According to E4-11, for most outdoor applications a minimum WRE of 75% is preferred.

The following Examples illustrate certain aspects of the present disclosure, but the scope of the present disclosure is not limited to the following Examples.

Materials

PEG 300, PEG 1000 and PEG 1450 are commercially available polyethylene glycols available under the trademark CARBOWAX™ from The Dow Chemical Company. PEG 1000 is dissolved in water to give a 30 wt. percent solution. PEG 1450 and PEG 300 are dissolved in water at the weight ratio of 8:2 to give a 30 wt. percent solution.

Epoxy Imbibed Thermoplastic Polymer Aqueous Dispersion. Maincote™ AEH-10 is a commercially available hybrid water dispersion of a Styrene Acrylic Latex with 30% Bisphenol A epoxy resins (available from the Dow Chemical Company). The Maincote™ AEH-10 has a solids content of 53%, an Epoxy Equivalent weight (EEW) of 1180 as supplied, a minimum film formation temperature (MFFT) of about 13° C. and a viscosity of less than 400 cPs. The dispersion is diluted to 30% solids by the addition of water. This dispersion is referred to below as “EITP”.

OUDRASperse™ WB 3001 is a commercially available epoxy dispersion from The Dow Chemical Company. The dispersion as received is 64% solids. This is diluted to 30% solids or 40% solids by adding water, as specified in Table 1.

Polyethyleneimine. An aqueous solution of polyethyleneimine having a 50 weight percent aqueous solution and a molecular weight of 750,000 is used (available from Sigma Aldrich, No. 181978). The polyethyleneimine is diluted to 5% solids by adding water. This dispersion is referred to below as “PEI”. This is added to the cellulosic material as a third treating step.

The other catalysts used for curing the epoxy are commercially available and include; diethylenetriamine (DETA), aminoethylpiperazine (AEP), and imidazole. These are added to the epoxy dispersion to give the corresponding percentage (weight) shown in Table 1.

Wood Treatment on small wood blocks. Eleven southern yellow pine blocks (4 cm*2 cm*0.5 cm) are provided, as labeled in Table 1, ten are treated as described herein and one is a control. Ten of the wood blocks are individually pressed down by a ring in an evacuated Parr reactor for half an hour followed by drawing in 80 ml of a first treating agent defined in Table 1. The reactor is pressurized to 150 psi under nitrogen and maintained for 60 min. The impregnated wood blocks are then placed in an oven in air at 60° C. for 48 h.

Two of the treated blocks are withheld from this procedure and used as comparative examples. The remaining eight treated wood block are each individually pressed down by a ring in an evacuated Parr reactor for half an hour followed by drawing in 80 ml of the modifying agent defined in Table 1. The reactor is pressurized to 150 psi under nitrogen and maintained for 60 min. The impregnated wood blocks are then placed in an oven in air at 60° C. for 48 h.

Two of the treated blocks are each individually pressed down by a ring in an evacuated Parr reactor for half an hour followed by drawing in 80 ml of the catalyst or curing agent defined in Table 1. The reactor is pressurized to 150 psi under nitrogen and maintained for 60 min. The impregnated wood blocks are then placed in an oven in air at 60° C. for 48 h.

A leaching test is performed by washing the wood blocks with deionized water at 35° C. for 8 hours and then dried in an oven at 60° C. overnight. The dimensional stability of the dried wood is then conducted following the AWPAS E4-11 procedure, with results listed in Table 1.

TABLE 1

| | | | Catalyst | | | | |
|---|---|---|---|---|---|---|---|
| | First | | or | Percentage | | Percentage | |
| | Treating | Modifying | Curing | of swelling | WRE | of swelling | WRE |
| Sample | Agent | Agent | Agent | (Initial) | (initial) | (leached) | (leached) |
| Control-1 | None | None | None | | 0% | | 0% |
| 1 | 30% PEG | 30% EITP | 5% PEI | 0% | 100% | 0.75% | 74.9% |
| | (1450 + 300) | | | | | | |
| 2 | 30% PEG | 30% | 5% PEI | 0.97% | 67.8% | 0.72% | 75.9% |
| | (1450 + 300) | OUDRASperse | | | | | |
| | | 3001 | | | | | |
| 3 | 30% PEG | 30% EITP | None | 0.76% | 74.5% | 1.9% | 36.7% |
| | (1450 + 300) | | | | | | |
| 4 | 30% PEG | 30% | None | 0.19% | 93.64% | 1.4% | 51.8% |
| | (1450 + 300) | OUDRASperse | | | | | |
| | | 3001 | | | | | |
| 5 | 30% PEG | 40% | None | 0.19% | 93.6% | 1.16% | 61.3% |
| | 1000 | OUDRASperse | | | | | |
| | | 3001 | | | | | |
| 6 | 30% PEG | 40% | None | 0.76% | 74.5% | 2.7% | 8.48% |
| | 1000 | OUDRASperse | | | | | |
| | | 3001, 2% | | | | | |
| | | Imidazole | | | | | |
| 7 | 30% PEG | 40% | None | 0.58% | 80.7% | — | — |
| | 1000 | OUDRASperse | | | | | |
| | | 3001, 2.26% | | | | | |
| | | DETA | | | | | |
| 8 | 30% PEG | 40% | None | 0.57% | 80.8% | — | — |
| | 1000 | OUDRASperse | | | | | |
| | | 3001, 5.56% | | | | | |
| | | AEP | | | | | |
| 9 | 30% PEG | None | None | 1.5% | 49.2% | — | — |
| | (1450/300) | | | | | | |
| 10 | 30% PEG | None | None | 0.925% | 69.16% | 3.9% | 30.11% |
| | 1000 | | | | | | |

As the table shows, treating wood with PEG initially provides a good water-repellency efficiency (WRE), but when leached with water the WRE is not good. Also when adding a catalyst or curing agent as a third step, the initial WRE and the leached WRE are both good. Adding the catalyst or curing agent to the modifying agent gives an initial good WRE but on leaching with water, the result is not as good. Without being limited by theory, these results suggest that the PEG can either react with the EITP or OUDRASperse to keep it from leaching with water or the EITP or OUDRASperse can form a film when treated with a catalyst or curing agent to coat the pores of the wood to keep the PEG from leaching.

Wood Treatment on Large Wood Blocks:

For large wood blocks, ASE % were calculated as:

$$A S E ( \% ) = \frac{100 \times ( {S}_{u} - {S}_{m} )}{{s}_{m}}$$

Where Sᵤ and Sₘ are the swelling coefficients of unmodified and modified wood, respectively.

The swelling coefficients were calculated as:

$$S ( \% ) = \frac{100 \times ( {V}_{2} - {V}_{1} )}{{V}_{1}}$$

Where V₂ is the volume of the saturated sample and V₁ that of the oven dried sample.

Seven southern yellow pine blocks (6.3 cm*6.3 cm*2.5 cm) are provided, as labeled in Table 2, six are treated as described herein and one is a control. Six of the wood blocks are individually pressed down by a ring in an evacuated Parr reactor for half an hour followed by drawing in 200 ml of a first treating agent defined in Table 2. The reactor is pressurized to 150 psi under nitrogen and maintained for 60 min. The impregnated wood blocks are then placed in an oven in air at 60° C. for 48 h.

The six treated wood blocks are then each individually pressed down by a ring in an evacuated Parr reactor for half an hour followed by drawing in 200 ml of the modifying agent defined in Table 2. The reactor is pressurized to 150 psi under nitrogen and maintained for 60 min. The impregnated wood blocks are then placed in an oven in air at 80° C. for 72 h.

The dimensional stability of the dried wood is then measured with results listed in Table 2.

TABLE 2

| | First Treating | Modifying | Percentage | |
|---|---|---|---|---|
| Sample | Agent | Agent | of swelling | ASE |
| Control-2 | none | none | | 0% |
| 11 | 2% imidazole and | 40% | −0.4695 | 114% |
| | 10% PEG 1000 | OUDRASperse | | |
| | aqueous solution | 3001 | | |
| 12 | 3% AEP | 40% | 0.066855 | 98.0% |
| | | OUDRASperse | | |
| | | 3001 | | |
| 13 | 3% AEP and 10% | 40% | 0.475436 | 85.8% |
| | PEG 1000 | OUDRASperse | | |
| | aqueous solution | 3001 | | |
| 14 | 3% AEP and 20% | 40% | 1.387458 | 58.6% |
| | PEG 1000 | OUDRASperse | | |
| | aqueous solution | 3001 | | |
| 15 | 2% imidazole and | 40% | −0.70176 | 120.9% |
| | 30% PEG 1000 | OUDRASperse | | |
| | aqueous solution | 3001 | | |
| 16 | 10% PEG 1000 | 40% | 0.592143 | 82.3% |
| | | OUDRASperse | | |
| | | 3001 | | |

Note, due to measurement techniques, when the percentage of swelling is very small, it may register as a negative number, as shown in the Table above.

1. A treated cellulosic material comprising:
a cellulosic material having a porous structure defining a plurality of pores, the cellulosic material comprising wood including wood or wood composite materials, at least a portion of the pores containing the reaction product of one or more of the following:

2. a water soluble polyol, an epoxy-containing resin, a catalyst or curing agent, and the cellulosic material. The treated cellulosic material of claim 1, wherein the water-soluble polyol is selected from the group of polyethylene glycol, polyvinyl alcohol, ethylene oxide/propylene oxide copolymer, ethoxylated glycerin, ethoxylated trimethyolpropane or ethoxylated sugars.

3. The treated cellulosic material of claim 1, wherein the epoxy-containing resin is derived from an aqueous dispersion comprising either an epoxy or an epoxy imbibed thermoplastic polymer.

4. The treated cellulosic material of claim 3, wherein the epoxy portion of the epoxy-containing resin is a diglycidyl ether of bisphenol A, the diglycidyl ether of bisphenol F, 1,4-butanediol diglycidyl ether, 1,6-hexanediol diglycidyl ether, the diglycidyl ester of phthalic acid, 1,4-cyclohexanedimethanol diglycidyl ether, 1,3-cyclohexanedimethanol diglycidyl ether, the diglycidyl ester of hexahydrophthalic acid, or a novolac resin, or a combination thereof.

5. The treated cellulosic material of claim 3, wherein the thermoplastic polymer portion of the epoxy imbibed thermoplastic polymer dispersion is derived from an acrylic latex.

6. A method for preparing a treated cellulosic material comprising:
(a) providing a cellulosic material;
(b) a first treatment protocol comprising impregnating the cellulosic material with a water-soluble polyol; and
(c) a second treatment protocol comprising impregnating the cellulosic material with an epoxy-containing resin.

7. The treated cellulosic material of claim 6, wherein the water-soluble polyol is selected from the group of polyethylene glycol, polyvinyl alcohol, ethylene oxide/propylene oxide copolymer, ethoxylated glycerin, ethoxylated trimethyolpropane or ethoxylated sugars.

8. The method of claim 6, wherein the water-soluble polyol is polyethylene glycol.

9. The method of claim 6, wherein the epoxy-containing resin is an epoxy or an epoxy imbibed thermoplastic polymer.

10. The treated cellulosic material of claim 9, wherein the epoxy portion of the epoxy imbibed thermoplastic polymer dispersion is a diglycidyl ether of bisphenol A, the diglycidyl ether of bisphenol F, 1,4-butanediol diglycidyl ether, 1,6-hexanediol diglycidyl ether, the diglycidyl ester of phthalic acid, 1,4-cyclohexanedimethanol diglycidyl ether, 1,3-cyclohexanedimethanol diglycidyl ether, the diglycidyl ester of hexahydrophthalic acid, or a novolac resin, or a combination thereof.

11. The treated cellulosic material of claim 9, wherein the thermoplastic polymer portion of the epoxy imbibed thermoplastic polymer dispersion is an acrylic latex.

12. The method of claim 6, wherein the impregnating of at least one of the first treatment protocol or the second treatment protocol is conducted under pressure greater than or lower than ambient.

13. The treated cellulosic material of claim 6, wherein the first treatment protocol further comprises an epoxy catalyst or a curing agent.

14. The method of claim 6, further comprising impregnating the cellulosic material with an additive.
